(19) United States
(12) Patent Application Publication
(10) Pub. No.: US 2009/0210512 A1
(43) Pub. Date: Aug. 20, 2009

(54) System, method, and program product for creating and sharing digital image output data across a network

(76) Inventors: Chanan Steinhart, Palo Alto, CA (US); Yishai Steinhart, Palo Alto, CA (US)

Correspondence Address: NORMAN FRIEDLAND, 2855 PGA BOULEVARD, SUITE 200, PALM BEACH GARDENS, FL, 33410, US

(21) Appl. No.: 12/070,200

(22) Filed: Feb. 15, 2008

(51) Int. Cl. G06F 15/16

(52) U.S. Cl. 709/218

(57) ABSTRACT

A method for creating and sharing graphical images among remote locations includes forming a cluster of client systems connected to a server, generating digital data representing graphical images within some of the client systems, and transmitting this data to the server, which forms one or more digital feed(s) including data representing the graphical images to be transmitted to client systems. During the transmission of the digital feed(s), the timing and composition of the feed(s) is not affected by actions of the client systems.

### RELATED APPLICATIONS

Not Applicable

### FEDERALLY SPONSORED RESEARCH OR DEVELOPMENT

Not Applicable

### BACKGROUND OF THE INVENTION

1. Field of the Invention

This invention relates to a method, a system, and a program product for sharing digital photo output data among multiple users, and, more particularly to such a method and system in which digital photographic output data is pushed along a network from one or more creators of such data to one or more receivers of such data, with the data being organized and presented in a predetermined manner.

2. Summary of the Background Information

The invention and widespread use of digital photography has opened many new ways for using photographic images. For example, in recent years, individuals have begun sharing digital photographic images through online web sites that host the shared images in “web galleries,” which other individuals can be invited to visit and view. Prominent web sites for sharing digital photographic images include sites named SHUTTERFLY, EASYSHARE, SNAPFISH, FLICKERS and FACE BOOK. Such web gallery sites are hosted on the World Wide Web (WWW) and therefore can be viewed only using a web browser. For example, after an individual contacts the web gallery site, he clicks on a reduced-size, thumbnail image to have the original image transferred to his browser for viewing. Since the images are viewed on line, unless they are protected by requiring the use of a passcode, they are available to anyone on line. Also they can be reviewed only when the viewer and the hosting site are connected to the WWW Such a site includes a number of individual galleries, each of which provides images from a single source, with a single user having uploaded image data in his possession to a host company hosting the web sight. The host company then creates a web gallery or web page using the image data. All images are then shared in an active way, with the individual who has been invited to view the images needing to go on line, logging in to the hosting web site and selecting the images to be viewed using a web browser (like Microsoft's IE or Mozilla Firefox)

U.S. Pat. No. 6,964,025 describes a tool that enables a user to form his own web gallery site, eliminating a need to submit images to one of the commercial web gallery sites. The tool enables a user to easily and automatically create a photo gallery of thumbnail images on a Web page. A user selects a group of original images, and the tool automatically produces a corresponding group of thumbnail images on the Web page, with hyperlinks to the corresponding original images. Four predefined templates arc included, each defining a different format for the thumbnail images including a vertically oriented gallery, a horizontally oriented gallery, a slide show gallery, and a montage gallery. Captions and descriptive text can also be entered and displayed for the thumbnail images in most of the style galleries. An edit function enables a user to add or delete images to existing galleries and to automatically modify the appearance of a photo gallery by selecting and applying a different template.

Web gallery sites operate according to the conventional client/server model of the World Wide Web, with client systems using browsers to reach the web site, with data being stored at the server of the web site, and with downloading occurring from the server to the client at the client's request.

Another network model, the peer-to-peer (P2P) model, can also be used for sharing photographic image data. According to the P2P network model, data is transferred from the system of one user to the system of another used, without the data being sent through, or stored within, a server system at a web site. If a server is used with the P2P model, it is used as a name server to provide information enabling the user systems to get together to share information or services through direct communications with one another over the network. For example, when a user computer contacts the name server with a request for a certain type of data, the name server provides the addresses of one or more user systems that have indicated they have the data available. Alternately, a P2P network can be established without using a server, with software on each of the user systems being provided to enable the system to contact each of the other systems in the network to share data or services. For example, the user systems provide an indication of the files or services they have available, and when particular data or a particular service is needed, the system needing the data or services polls the other systems that have indicated that the data or service is available. A simple example of the P2P model, which is nevertheless useful for delivering photographic image data, is the use of email communications, with the data being included as an attachment.

The patent literature includes a number of descriptions of systems and methods for providing or improving the sharing of photographic image data over a P2P network. For example, US 2006/0136551 A1 describes a method and system for serving content from a peer server in a photosharing peer-to-peer network is disclosed, wherein the peer server stores a web album and at least one associated digital image. Aspects of the invention include prior to the peer server going off-line, the peer server initiates a synchronization with a proxy server and a guest content server in which the web page a web page descriptor defining the web album is copied from the peer server to the guest content server, and the image associated with the web album is copied from the peer server to the proxy server. In response to a request from a requesting computer to view content stored in the peer computer when the peer server is off-line, the request is fulfilled by forwarding the web page from the guest content server to the requesting computer, and forwarding the image associated with a web page from the proxy server to the requesting computer, thereby successfully serving content from the peer server even when the peer server is off-line.

U.S. Pat. Appl. Pub. No. 2004/0215625 A1 describes a method and system for distributing affiliate images in a peer-to-peer (P2P) photosharing network comprising multiple peer nodes and a peer server, wherein each of the peer nodes execute a peer application that allows the peer nodes to communicate with each other and with the peer server over a network. Aspects of the present invention include customizing the peer application for the affiliate by branding the peer application with brand identifiers of the affiliate and by bundling low-resolution images of the affiliate with the customized peer application. Thereafter, the customized peer application is distributed directly to the fan base of the corresponding affiliate. During execution of the customized peer application, a user may place an order for merchandise imprinted with at least one of the low-resolution images. When the order is subsequently processed by the peer server, any low-resolution image in the order is replaced with its corresponding high-resolution image for final printing.

U.S. Pat. Appl. Pub. No. 2003/0069801 A1 describes a method of ordering a digital image service over a communication network. The method includes the steps of: (a) at a first image system, viewing and selecting at least one digital image; (b) selecting the digital image service to be ordered and generating an image order request comprised of the at least one digital image and order information; (c) selecting a second image system, remote from the first image system, for providing the digital image service; (d) transmitting the image order request over the communication network from the first image system to the second image system; (e) at the second image system, accessing the at least one digital image and order information from the image order request; and (f) providing the requested digital image service whereby the at least one digital image is incorporated in an imaging product, processed to produce an edited digital image, stored, retrieved, or transmitted over the communication network. The system and method of the present invention provides a developer, third party equipment, storage providers and/or retailer, with the ability to network connectivity between image systems which provide image capture, process, display and storage capability and image systems which provide image services (for example, fulfilling an image order request) by employing a common software interface system. Image services may range from imaging products (i.e., digital photographic hard copy prints, digital media containing images, embedded image software products and other image-related products) to imaging services like image storage and retrieval, image processing and image transmission.

U.S. Pat. No. 7,068,309 B2 describes a system and method for providing a peer-to-peer photosharing environment. The system includes: manual and automatic photo annotation at the client; periodic client/server synchronization; an index of client photos on a central server or a photo database that is resident on the central server, which is updated by the client-server synchronization function; end-user search functionality to search the centralized index or photo database; and transmission of the relevant photos to the client via an on-line image cache. In one embodiment, one client's new photos are automatically displayed on another client's computer (e.g., via screen saver or another mechanism).

A European Patent Application, EP 1,223,530 A2 describes a system and method for offering and sharing digital photographic data, with the system including a printer for carrying out a printing service in association with an image sharing server. Planners are invited to develop planned pages on the image sharing server, and images contributed from general users are accepted through registered planned pages, with a service for offering contributed images for pay (ordered printing, downloading, etc.) being developed. A manager of the image sharing server performs centralized management, including carrying out services and collecting charges for the services. Instances of use of each service are totalized with respect to each planned page and with respect to each contributor, and portions of a profit made by offering the service are respectively returned to the corresponding planner and contributor. Each planner and each contributor are periodically notified of the totalization results. Thus, a system is provided in which each service planner can easily develop his original planned page without holding an individual data base server and a Web server of its own, and portions of a profit made by offering planned pages are respectively returned to the planner and contributors. Also, the manager of operations for the services in this system prepares a portal site server, a gallery provision server, a photograph storage server, and a printing service provider on the Internet and invites content providers to utilize the system. The printing service provider collects orders accepted through planned pages from users, performs printing according to the orders, and delivers finished prints to the users. In this system, a portal site service, a gallery provision service, a photograph storage service and page making GUI component provision services are offered to assist opening a gallery page. Thus, finely divided functions and services for exhibiting contents such as photographs on the network (60) are provided, thereby enabling each contents holder to easily develop a gallery site.

Other patent documents describe improvements to the process for editing digital images. For example, U.S. Pat. No. 7,065,249 B2 describes a system and method for editing images. Each image editing operation is described by a few parameters. Multiple users can share image processing changes by sharing a few set of parameters instead of the whole bitmaps of the images. An Editing List describes the parameters defining the image changes. The size of Editing List is very small and is ideal for network transmission and collaboration. Image Editing Lists are independent of the images themselves. By decoupling the Image Editing Lists from the original bitmap images, other advantages are obtained. For instance, the same Editing List can be applied to other images and also to multiple images at the same time. Rendering of the modified images can be performed at a later time and only when necessary. In case of collaborative editing, the transmission time is reduced drastically.

U.S. Pat. Appl. Pub. No. 2002/0063901 A1 describes a method of editing, storing and using digital photographic images for the purpose of producing finished collections of photographs. In the inventive method, digitized photographic images are first combined with editing information, and that combination is utilized by the originating photographer to prepare the finished photographs. The originating photographer also provides instructions for further editing, collating, masking and grouping the photographs for presentation and sale over a network, such as the Internet.

Another network model is the broadcast model, in which a data source pushes data along the network, with the user merely deciding when to connect or disconnect from the network. Preferably, the various types of data are transmitted in the form of programs that are organized according to a schedule, so that users can know when to access the data to see the type of material they want to view. Conventional television, whether broadcast over the air or transmitted through a cable system, is an example of the broadcast model. This model is increasingly being used to transmit programs, similar in content to television programs, from web sites over the Internet.

What is needed is a system and method for generating and sharing photographic image content, with the method combining various features of the client/server network model, the P2P network model, and the broadcast network model.

### SUMMARY OF THE INVENTION

In accordance with one aspect of the invention, a method is provided for creating and sharing graphical images among remote locations. The method includes forming a cluster of client systems connected to a server over a network. The cluster is formed by storing an address identifying each of the client systems in the cluster in an active cluster database within the server. After the cluster is formed, digital data representing graphical images is generated in a plurality of the client systems. Then, the digital data is transmitted over the network to the server.

After receiving the digital data, the server forms content from the digital data to include representations of the graphical images represented within the digital data. Then the server forms a digital data feed including this content and transmits the digital data feed over the network to at least one of the client systems within the cluster. The composition and timing of the content within the digital data feed is not affected by actions of the client systems during transmission of the digital data feed. The server may form a plurality of such data feeds, which are transmitted both to client systems inside the cluster and outside the cluster.

The method for forming the cluster of client systems may be performed by one of the client systems, acting as an administrator, calling the server and transmitting the address identifying each of the client systems to be included in the cluster to the server.

The method for creating and sharing graphical images may additionally include transmitting a source suite program from the server to be downloaded by client systems in the cluster. Such a source suite program includes program instructions for generating digital data describing graphical images and for transmitting the digital data to the server over the network.

The active cluster database may additionally include data describing source rules and destination rules. The source rules, which identify the client systems that are to generate the digital data representing graphical images, are derived from information transmitted to the server by the administrative client system as the cluster is created. The source rules may additionally be updated with the transmission of digital data representing graphical images. The destination rules, which identify when a client system is to receive the data feed(s) are derived from data transmitted to the server from the client system receiving the data feed.

The content formed within the server may include a project having a number of images formed by digital data transmitted to the server by a number of client systems within the cluster. Data representing the images is stored in a work in process database within the server until data including representations of all the images has been received by the server.

### BRIEF DESCRIPTION OF THE DRAWINGS

FIG. 1 is a schematic view of a system built in accordance with the invention.

FIG. 2 is a schematic view of an active device within the system of FIG. 1;

FIG. 3 is a flow chart of processes occurring within an overall method performed within the system of FIG. 1;

FIG. 4 is flow chart showing a first example of data flow within the system of FIG. 1 between devices and a server therein;

FIG. 5 is flow chart showing a second example of data flow within the system of FIG. 1 between devices and a server therein;

FIG. 6 is flow chart showing a third example of data flow within the system of FIG. 1 between devices and a server therein;

FIG. 7 is a flow chart showing processes occurring during the execution of a source suite program within the active device of FIG. 2;

FIG. 8 is a display screen view of a main menu dialog box displayed during the execution of the program of FIG. 7;

FIG. 9 is a display screen view of a create menu dialog box displayed during the execution of a subroutine of the program of FIG. 7;

FIG. 10 is a flow chart showing processes occurring during the execution of the subroutine of the program of FIG. 7,

FIG. 11 is a schematic view of a server within the system of FIG. 1;

FIG. 12 is a display screen dialog box displayed by the browser of a client system contacting the server of FIG. 11 over an administrative link thereto;

FIG. 13 is a first display screen dialog box displayed by the browser of a client system following selection of a command button in the dialog box of FIG. 12.

FIG. 14 is a second display screen dialog box displayed by the browser of a client system following selection of another command button in the dialog box of FIG. 12;

FIG. 15 is a flow chart showing processes occurring during execution of an administrative subroutine in the server of FIG. 11;

FIG. 16 is a flow chart showing processes occurring during execution of a download subroutine in the server of FIG. 11;

FIG. 17 is a flow chart showing processes occurring during execution of a create content subroutine in the server of FIG. 11; and

FIG. 18 is a flow chart showing processes occurring during execution of a distribute content subroutine in the server of FIG. 11.

### DETAILED DESCRIPTION OF THE INVENTION

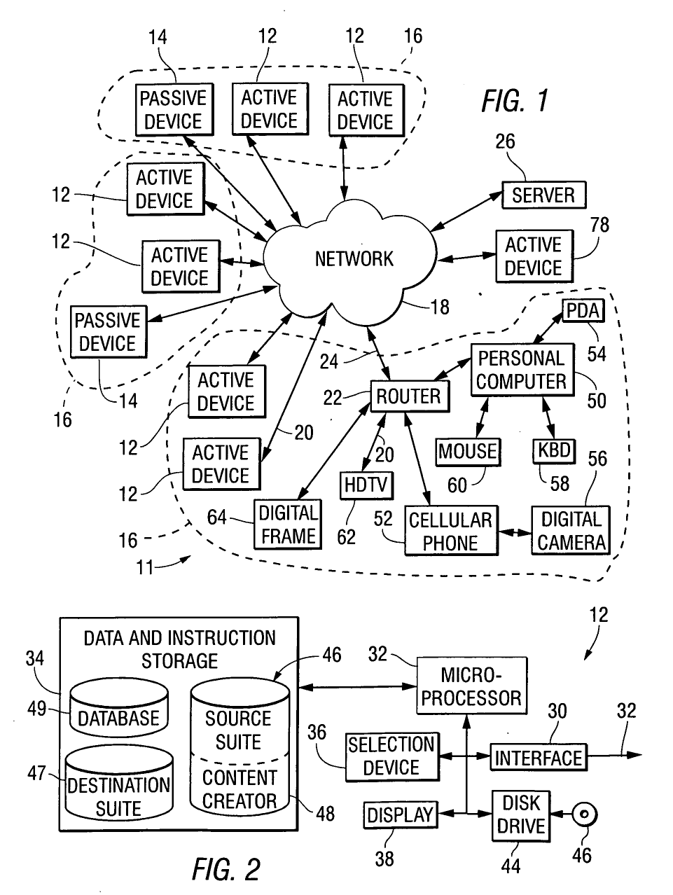

FIG. 1 is a schematic view of a system 10 built in accordance with the present invention to allow client systems 11, such as active devices 12 and passive devices 14, which may be remote from one another, to be joined into clusters 16 to create and share digital image data, such as digital data describing photographs, movies, and illustrations, and constructions including digital image data, such as albums, books slideshows, calendars, and cards (as postcards greeting cards, etc). Each of the active devices 12, and each of the passive devices 14 within a cluster 16 are connected to a network 18, which is, for example, the Internet. (As the terms used herein, an active device 12 is one that can execute programs, display data, and transmit data to the network 18, while a passive device can merely display data received from the network 18.) The devices 12, 14 may be directly connected to the network 18 by links 20, or through a router 22, which is in turn connected to the network 18 by a link 24. The individual links 20, 24 may be wired or wireless. The system 10 additionally includes a server 26, which arranges the client systems 11 into clusters 16, and which facilitates the creation of digital image data by the active devices 12 within a cluster 16 and the distribution of such digital image data among the active devices 12 and passive devices 14 within the same cluster 16.

FIG. 2 is a schematic view of one of active devices 12, which includes a microprocessor 32, data and instruction storage 34, a selection device 36 for providing user inputs, a display 38 for displaying images or other information, and an interface 40 providing a means to connect to the network 18 through a link 20. The active device 12 may additionally include a disk drive 44 for reading data from a computer readable medium, such as an optical disk 45.

Data and instruction storage 34 holds a source suite program 46 and a delivery suite program 47, both of which have been transmitted from the server 26 and downloaded from the network 10. The source suite program 46 includes a content creator subroutine 48 that is used to create digital data representing graphical images for transmission to the server 26. Data and instruction storage 34 additionally holds a database 49 storing digital image data created using the content creator subroutine 48 and received from the server 26. Data and instruction storage 34 is considered to form a computer readable medium.

In general, the active device 12 is a device that can generate and communicate serial data, such as a personal computer 50, a cellular phone 52, a personal data assistant (PDA) 54, or a digital camera 56, . For example, if an active device 12 is a personal computer 50, the selection device 36 comprises the keyboard 58 of the computer 50 and a pointing device 60, such as a mouse. Each other device that can be used an active device 12 includes at least a number of buttons that can be used as the selection device 36 to select an image for transmission, etc. If the active device 12 is a personal computer, the interface 40 may include a network interface card (NIC) for wired connection to the network 18 or a Wi-Fi transceiver for connection to the network 18 through a wireless router or access point (not shown). Cellular phones that use cellular communications to communicate digital information with the Internet are now widely available, so this method of communication can be readily be used to provide the interface capability if the active device 12 is a cellular phone 52. Digital cameras 56 and PDAs 54 are now being provided with a capability for wireless communication of digital data through Bluetooth technology and through wired connections, such as USB cables, so such devices can transmit and receive data from a device, such as a personal computer 50, that is connected to the network 18 or through a cellular telephone 52 having, for example, Bluetooth capabilities, that is connected to the network 18 through cellular communications. Additionally, the clusters 16 may include passive devices 14, that only receive and display digital image data, such as an HDTV 62 and a digital frame 64. Such devices 14 are each connected to the network 18, with external connection circuits being attached, if necessary.

FIG. 3 is a flow chart of processes occurring within an overall method 74 performed within the system 10 during the formation of a cluster and the creation of content in the form of digital image data. This method begins in step 76 when an active device 78 (shown in FIG. 1), not included in one of the clusters 16 contacts the server 26. For example, the active device 78 contacts the server 26 through a web site, with a button on the display screen presented by the web site being selected to indicate a desire to sign on as an administrator. Next, in step 80, the active device 78, now an administrator, transmits information identifying the devices to be included within the cluster 16 being developed. Preferably, the information includes a first list identifying active devices 12, and a second list identifying passive devices 14, if any. For example, the devices may be identified by URLs of the devices 12, 14. Then, in step 82, the administrator 78 transmits data representing source rules to the server 26. For example, these source rules describe the types of images that can be contributed in the development of content for transmission, which active devices 12 within the cluster 16 can develop certain forms of content, what forms of content are to be downloaded from the server 26, which devices 12, 14 can receive the content, and which permission rules are required to receive the content. In step 84, data describing the devices 12, 14 is stored within the server 26. Then, in step 86, the server 26 transmits the destination suite program 47 (shown in FIG. 2) to each of the active devices 12 within the newly-formed cluster 16. The active devices 12 then, in step 88, use the destination suite program 47 to generate destination rules and to send these rules to the server 26. The destination rules determine, for example, the types of content that will be sent to the individual active device 12 and to associated passive devices 14, if any, and the times at which such content will be sent. Next, in step 90, the server 26 transmits the source suite program 46 to each of the active devices 12 within the cluster 16.

At this point, the process of setting up the cluster 16 has been completed, so, in step 92, the active devices 12 within the cluster 16 use the content creator subroutine 48 within the source suite program 46 to generate content, including digital data describing images, with is then transmitted over the network 18 to the server 26. Then, in step 94, a determination is made of whether further changes are needed in the content transmitted in step 92. For example, it may be necessary to combine image data from several of the active devices 12 into a photo album, gallery, or calendar. If such changes are not needed, the content is distributed by the server 26 in step 96. If such changes are needed, they applied by the server 26 before the content is distributed in step 96.

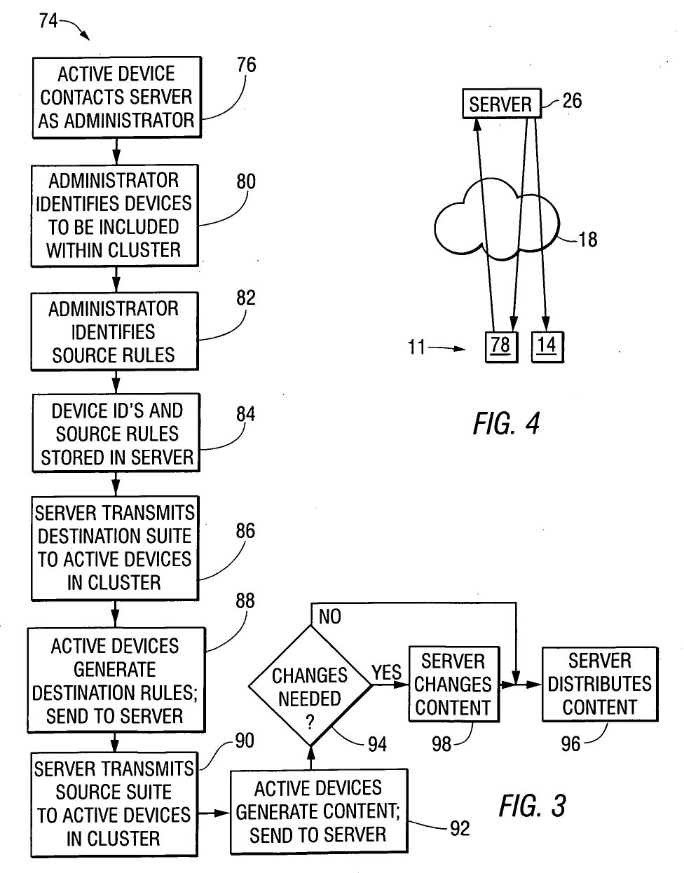

The source rules and destination rules are used to determine the pattern in which data flows between the client systems 11 and the server 26 through the network 18. Examples of such patterns of data flow will now be discussed, with reference being made to FIGS. 4-6.

FIG. 4 is a flow chart showing a first example of data flow between client systems 11 and the server 16, with the cluster 16 being defined so that only the administrator 78 and a single passive device 14 are included therein. For example, his arrangement allows a user operating the administrator 78 to prepare slideshows for his passive device 14, such as a digital picture frame or an HDTV.

FIG. 5 is a flow chart showing a second example of data flow between client systems 11 and the server 16, with the server 26 being used to facilitate communication among client systems 11 within the cluster 16. Image data 100 is sent from a first group 101Of the active devices 12, 78 within the cluster 16 and is then transmitted from the server 26 to a second group 102 of the active and passive 12, 14, 78, which may overlap the first group 101. The data transmitted from the server may be in the form of multiple data feeds 103, 104, with the data being differentiated, for example, according to subject matter or according to the types of devices 12, 14, in which the image data can be readily displayed. This arrangement, which provides some of the advantages associated with peer-to-peer networks, in that communications are facilitated only between a limited number of network elements, is particularly suitable for sharing images having interest within a limited audience, such as family photographs.

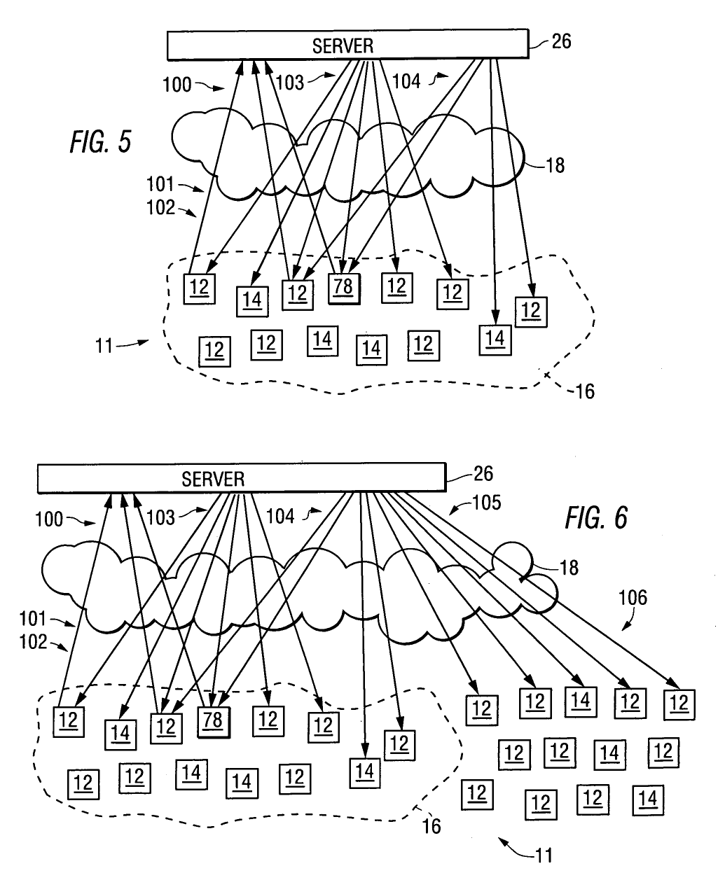

FIG. 6 is a flow chart showing a third example of data flow between client systems 11 and the server 16, with additional data 105 being sent to devices 106 outside the cluster 16. This arrangement is particularly useful to form one or more continuous slideshows for broadcast outside the cluster 16, with certain active devices 12, 78 being used to generate advertising content for display along with other image data.

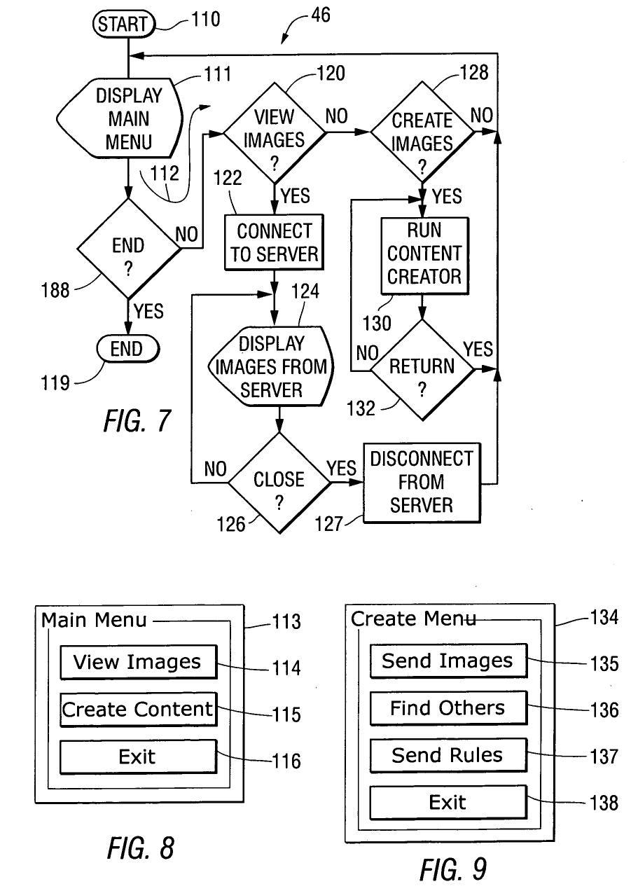

FIG. 7 is a flow chart of processes occurring during the execution of the source suite program 46 within the microprocessor 32 of an active device 12. Since it is understood that the active device 12 is generally used for a number of purposes, the source suit program 46 is provided in a form that can be loaded, used, and then closed. When the program 46 is loaded to start in step 110, a main menu dialog box is displayed in step 111, with the source suite program 46 entering a loop 112 waiting for the user to select a command button on the main menus.

FIG. 8 is a display screen view of a main menu dialog box 113 displayed in step 111. The main menu dialog box 113 includes a first command button 114, which the user selects to view images being transmitted by the server 26, a second command button 115, which the user selects to begin a process of making an image having digital data to be transmitted to the server 26, and a third command button 116, which the user selects to close the source suite program 46, with the active device 12 being disconnected from the server 26 in step 127, allowing the active device 12 to be used for other purposes.

Thus, when it is determined in step 118 that the user has selected the third command button 116, the execution of the source suite program is ended in step 119. When it is determined in step 120 that the user has selected the first command button 114, the active device 12 is connected to the server 26 in step 122, with the process of displaying images transmitted from the server 26 beginning in step 124. This process is then ended in step 126 when the user selects the close button of his browser, which is typically identified with an “X,” and located in the upper right corner of the display screen. When it is determined in step 128 that the user has selected the second command button 115, the content creator subroutine 48 (shown in FIG. 2) is run in step 130. When the content creator subroutine 48 is then ended in step 132, the source suite program 46 returns to the loop 112, awaiting another user selection of a command button in the main menu dialog box 113.

FIG. 9 is a display screen view of a create menu dialog box 134, which is displayed during execution of the content creator subroutine in step 130. The dialog box 124 includes a first command button 135, which the user selects to develop content in the form of digital images that are sent to the server 26, with such content being based on one or more images for which data is stored in the database 49 of the active device 12. If one or more additional images are needed, the user can select the third command button 137 to view images for which data is stored within the server 26. The user may also select the fourth command button 138 to exit the subroutine 48, returning to the main menu of dialog box 113.

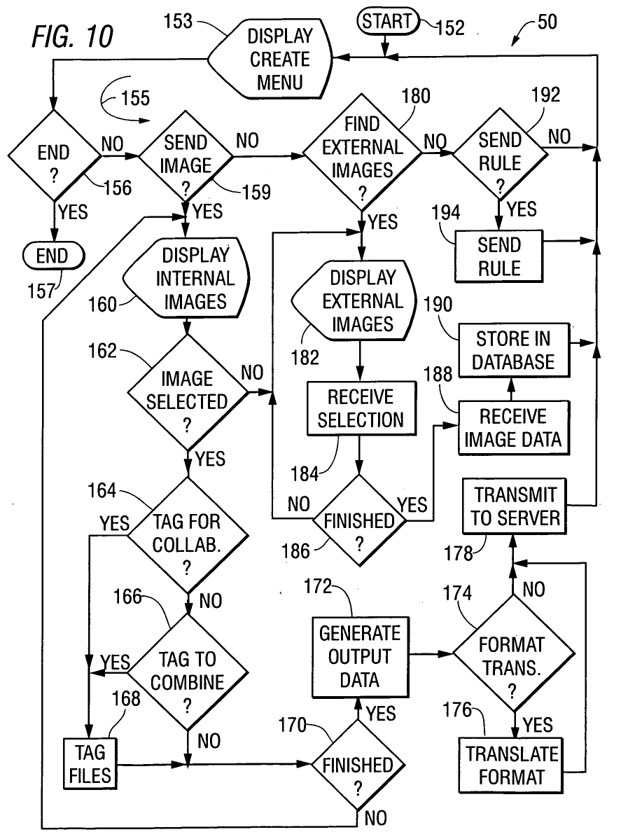

FIG. 10 is a flow chart showing processes occurring within the active device 12 during the execution of the content creator subroutine 48 in step 130 of the source suite program 40 in accordance with the invention. The content creator subroutine 48 is started in step 152, being called by the source suite program, with the create menu dialog box 138 being displayed in step 153, and with a loop 155 being entered to determine when one of the command buttons of the create menu dialog box 134 has been selected. If it is then determined in step 156 that the user has selected the selected the fourth command button 138 of the create menu dialog box 134, the content creator subroutine 48 is ended in step 57.

If it is determined in step 159 that the user has selected the first command button 135 to send data for one or more images to the server 14, the internal images, which are stored within the database 42 of the active device 12 are displayed on the display 38 thereof in step 160, preferably in the form of thumbnail images. Then, in step 162, a further determination is made of whether the user has selected an image. If he has, his selection, which is, for example, made by manipulating a cursor on the display 38 to select one or more thumbnail images, is received. Next, in step 164, further user inputs are evaluated to determine whether the selected file or files should be tagged for inclusion with one or more additional files being generated on one or more other active devices 12 in a combined image. Then, in step 166, a determination is made of whether the images for which a selection has been received in step 162 are to be tagged for inclusion with one another in a combined image. If it is determined in steps 164 and 166 that such tagging is required, the file(s) that have been selected are tagged in step 168. Next, in step 170, a further determination is made of whether the user is finished selecting images for transmission to the server. For example, the determinations of steps 164, 166, and 170 may be made in response to selections made using the selection device 36, with such selections being prompted by information displayed on the display 38. If it is determined in step 170 that the user is not finished selecting images for which data is to be transmitted, the routine 50 returns to step 160, so that the user can select one or more images.

On the other hand, if it is determined in step 170 that the user is finished selecting images for transmission, the subroutine 48 proceeds to step 172, in which output data for the selected images is generated Next, in step 174, it is determined whether it is necessary to translate the format of the output data generated in step 172 in order to make the data suitable for viewing on a conventional viewing device. If such translation is needed, it is performed in step 176. Then, in step 178, whether a format translation was applied or not, the data is transmitted to the server 26.

If it is determined in step 159 that the user has not selected sending image data to the server 26, the subroutine 48 proceeds to step 180, in which a determination is made of whether the user has selected to find external image data, which can be located through communications with the server 26. If such a selection is being made, such external images are displayed on the display 38 in step 182. Then, in step 184, a selection of the images from the user is received. Next, in step 1186, a determination is made of whether the user has indicated that he is finished with the selection process. If he is not, the subroutine 46 returns to step 182 to continue showing external images from which a selection can be made. If he is, the subroutine 48 proceeds to step 188, in which data for the selected images is requested from the server 26. Next, in step 190, as image data is received from the server 14, it is stored within the database 49 of the active device 12, with the routine 48 returning to the loop 155 to wait for a user selection.

Additionally, if it is determined in step 162 that additional images, not available within the database 48, are needed to form the images for which data will be sent to the server 26, the subroutine 48 proceeds to step 82 so that external images can be selected from data sent from the server 26, with data from selected external images being stored within the database 49 of the active device 12 for subsequent use.

If it is determined in step 180 that the user has not selected to find data for external images, the subroutine 48 proceeds to step 192 in which a further determination is made, of whether the user has selected to generate or modify one or more rules regarding how the images are to be distributed by the server 26. If he has not, the subroutine 48 returns to loop 155 to wait for a user selection. If he has selected to send one or more rules, the new rules are composed and sent in step 194, with the subroutine 48 again returning to loop 155 to wait for a user selection.

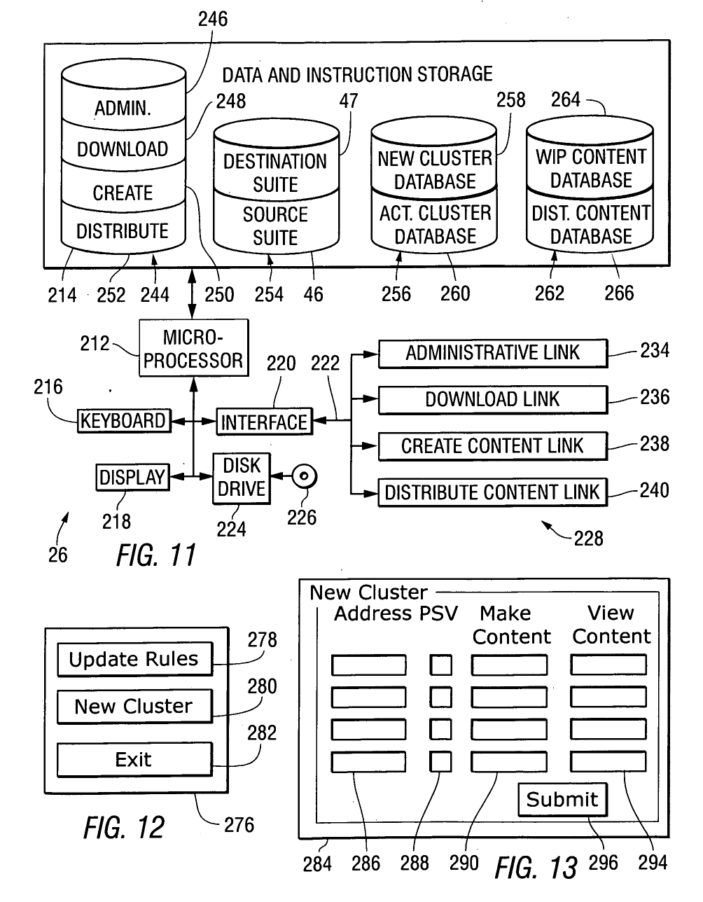

FIG. 11 is a schematic view of the server 26, which includes a microprocessor 212, data and instruction storage 214, a keyboard 216 for providing user inputs, a display 218 for displaying images or other information, an interface circuit 220 providing a means to connect to the network 18 through a link 222, and a disk drive 224 for reading data from a computer readable medium storing a computer program product, such as an optical disk 226. Preferably, the server 26 may be accessed over the network 18 through a number of links 228, each of which is associated with a different function, or set of functions, to be performed by the server 26. The server 26 has a capability for providing simultaneous communications with a number of client systems over a number of links. For example an administrative link 234 is accessed by the active device 78 (shown in FIG. 1) to establish a new cluster 16 or to change the rules previously established for an existing cluster 16. A download link 236 is accessed to download programs stored within the server 26 to the active devices 12. A create content link 238 is used by an active device 12 to submit content for distribution from the server 26. A distribute content link 240 is used to distribute content from the server 26.

Data and instruction storage 214, which includes computer readable media for storing computer readable code, holds instructions for a number of subroutines 244, each associated with one of the links 254 and operative when a call is received on the associated link 228. The administrative subroutine 246 starts when a call is received on the administrative link 234. The download subroutine 248 starts when a call is received through the download link 236. The create content subroutine 250 starts when a call is received through the create content link 238. The distribute contact subroutine 252 starts when a call is received through the distribute contact link 240.

Data and instruction storage 214 also holds programs 254 to be downloaded to active devices 78, 12 calling on the download link 236, in the form of the destination suite 47 and the source suite 46. Databases 256 storing descriptions of the devices 78, 12, 14, and rules that have been established for the transmission of content to these devices 78, 12, 14 include a new cluster database, storing such data during the formation of each new cluster 16,and an active cluster database 260 storing such data for clusters that have been formed. Databases 262, storing content that has been created for distribution, include a WIP (work in process) database 264 storing content for projects that have not yet been completed and a distribute content database 266 storing content within projects that have been completed for distribution.

FIG. 12 is a display screen view of a dialog box 276 forming a portion of a welcome screen displayed by the browser of an active device 78, 12 contacting the server 26 through the administrative link 234. The dialog box 276 includes a first command button 278, which the user selects to access a means to update rules that have been established to control the distribution of content, a second command button 280, which the user selects to form a new cluster 16, and a third command button 282, which the user selects to disconnect from the server 26.

FIG. 13 is a display screen view of a dialog box 284 that is displayed to the user by the browser after he selects the second command button 280. The dialog box 284 includes a first column of text boxes 286 in which the user of an active device 73 types the address, such as a URL, of each active device 12 and of each passive device 14 to be added into a cluster 16 to be formed. Check boxes 288 are used to indicate which of the devices indicated by addresses in text boxes 296 are passive devices 14. Text boxes 290 and 292 are used to indicate which of the active devices 78, 12 are able to provide content and, respectively, which of the active devices 78, 12, and the passive devices 14 are to be able to view the content. Alphanumeric symbols may be typed within the text boxes 290, 292 to indicate types of content that can be made and viewed by individual devices 18, 12, 14. When the user is satisfied with the data entered using the dialog box 284, he selects the command button 294 to submit the data to the server 26.

It is expected that source rules, regarding which devices are allowed to make each type of content, and destination rules, regarding which devices will receive which type of content will be viewed by which devices, will generally be set by the administrative device 78 when the cluster 16 is formed, and that destination rules concerning when a particular device 12, 24 will view particular types of content will be set using the download link 236 when a destination device downloads programs 254 in the process of establishing the cluster 16. However, it is further understood that various changes to rules may be desired and that destination rules for a passive device 14 will need to be provided through one of the active devices 78, 12, since a passive device 14 cannot have such interactions with the server.

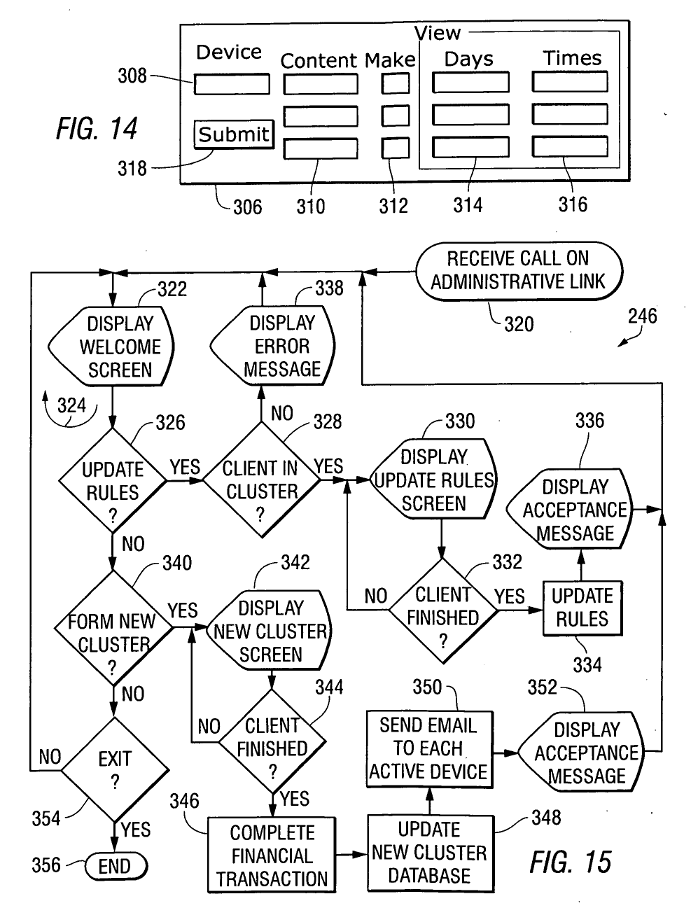

Therefore, FIG. 14 is a display screen view of a dialog box 306 that is displayed to the user by the browser when it is determined that he wishes to set or change the rules for a device 78, 12, 14. The dialog box 306 includes a text box 308 in which an identifier, such as the network address, of the device 78, 12, 14, for which the rules are to be set or changed. A column of text boxes 310 is used to indicate, with alphanumeric characters, different types of content that are to be made, with an adjacent column of check boxes 312 being used to indicate the types of content that can be made using the device identified in the text box 308. The dates and times during which each type of content can be viewed by the device identified in the text box 308 are then entered in the text boxes 314 and 316, respectively. When the user is satisfied with the data displayed within the dialog box 306, he selects the submit command button 318 to send the data to the server 26.

FIG. 15 is a flow chart showing processes occurring within the administrative subroutine 246 after a client device, such as an active device 78, 12, contacts the server 26 through the administrative link 234 in step 320. Next, in step 322, the server 26 causes the browser of the calling device 78, 12 to display a welcome screen including the dialog box 276 of FIG. 12. The administrative subroutine 246 then enters a loop 324 waiting for one of the command buttons of the dialog box 276 to be selected.

For example, if it is determined in step 326 that the first command button 278 has been selected, in step 328, the address of the device 78, 12 (client system) calling the server 26 is checked against addresses listed within the active cluster data base to determine whether the client system is a device 78, 12 within one of the clusters 16. If it is, an update rules screen including the dialog box 306 is displayed in step 330, allowing the calling device 78, 12 to make changes in the rules. When it is then determined, in step 332, that the the user of the device 78, 12 placing the call is finished with the changes to rules, as indicated by the selection of the submit command button 318, the rules are updated in step 334, with an acceptance message being displayed by the browser of the device 78, 12 in step 336, and with the administrative subroutine 246 returning to cause the browser to display the welcome screen in step 222. On the other hand, if it is determined in step 328 that the device 78, 12 is not within one of the clusters 16, the browser of the device i78, 12 is caused to display an error message in step 338 before again displaying the welcome screen in step 322.

If it is determined in step 340 that the second command button 280 of the dialog box 276 has been selected, the browser of the calling device 78, 12 is caused to display a new cluster screen including the dialog box 284 in step 342. Then, the user enters information to form a new cluster 16, as described above in reference to FIG. 13. When it is determined in step 344 that he has selected the submit command button 296, the administrative subroutine 246 proceeds to step 346, in which a financial transaction is completed with the calling device, which is now established as an administrator 78. For example, a credit card may be used for payment in a manner well known to those skilled in the art of electronic commerce. Next, in step 348, the new cluster database 258 is updated to include data records for the devices 78, 12, 14 described using the new cluster dialog box in step 342. Then, in step 350, the server 26 sends an email to each of the devices 78, 12, 14 described using the new cluster dialog box in step 354, providing a link to the download link 236. Then, in step 352, the browser of the active device 78 is caused to display an acceptance message, before the administrative subroutine 246 returns to step 322, causing the welcome screen to be displayed.

If it is determined in step 354 that the third command button 282 of the dialog box 376 has been selected, the administrative subroutine 246 ends in step 356, with the call received in step 320 being terminated.

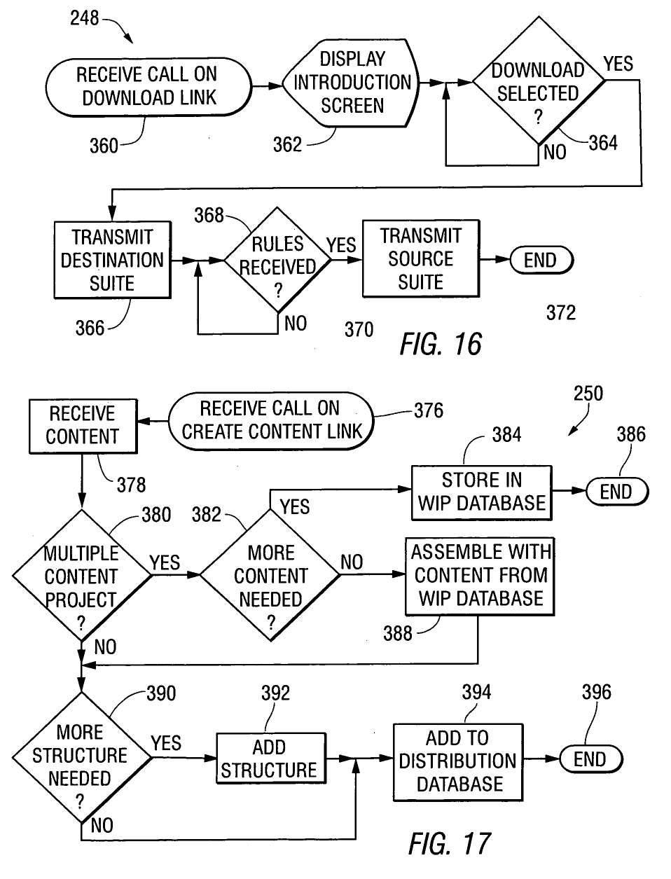

FIG. 16 is a flow chart showing processes occurring within the download subroutine 248 after a client device, such as an active device 78, 12, contacts the server 26 through the download link 236 in step 320, using, for example a link provided within an email sent in step 350. In step 362, the browser of the active device 78, 12 is caused to display an introduction screen providing the user with a choice to download the programs. When it is determined in step 364 that he has chosen to do so, the destination suite 47 is transmitted from the server 26 to be downloaded by the calling active device 78, 12. Then, in step 368, a determination is made of whether the user of the calling active device 78 has responded with an identification of destination rules describing the types of content to be viewed and the times for viewing the content. For example, the user may indicate that he wants to view all of the content being developed. If it is determined in step 368 information regarding such rules has been sent, the source suite 46 is sent in step 370, with the download subroutine 248 then ending in step 372.

FIG. 17 is a flow chart showing processes occurring during execution of the create content subroutine 250 after a client device, such as an active device 78, 12, contacts the server 26 through the create content link 238 in step 376. In step 378, content is received from the active device 78, 12. Then, in step 380, tags associated with the content received in step 378 are examined to determine whether the content is part of a project requiring multiple content. If it is, a further determination is made in step 382 of whether additional content is needed to complete the project. If it is, the content received in step 378 is stored in the WIP content database 264 in step 384, with the create content subroutine ending in step 386. If no more content is needed to complete the project, the content received in step 378 is assembled with other content from the WIP content database 264 in step 388. Then, or alternatively following a determination in step 380 that the content received in step 378 is not part of a project requiring multiple content, a further determination is made in step 390 of Whether more structure is needed. For example, the project may comprise making a calendar using content provided from various sources to form pictures, with the server 28 providing the remaining structure of the calendar. If more content is needed, it is added in step 392. In either case, the content is added to the distribute content database 262 in step 394 for distribution according to the rules stored within the active cluster database 260, with the create content subroutine 250 ending in step 396.

The devices 78, 12, and 14 may remain connected to the server 26 to receive content being distributed from the distributing content database 262 in accordance with the stored rules. Such operation may be particularly desirable for a passive device such as a digital picture frame. On the other hand, it is generally desirable to use the device 78, 12, or 14 for other purposes as well, so a distribute content link 240 is provided for a device 78, 12, 14 contacting the server 26 to receive the content being distributed from the distribute content database 266.

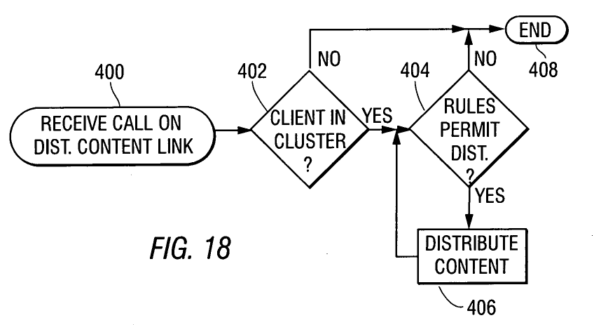

FIG. 18 is a flow chart showing processes occurring during execution of the distribute content subroutine 252 after a client device, such as an active device 78, 12, contacts the server 26 through the distribute content link 240 in step 400. In the next step 402, the active cluster database 260 is checked to determine whether the device 78, 12, 14 is included in one of the clusters 16. Next, in step 404, a further determination is made from the data within the active cluster database 260 of whether the rules stored within this database 260 permit the distribution of content to the particular device that has contacted the server. If they do, the content is distributed to the device in step 406; otherwise execution of the distribute content subroutine 252 ends in step 408. If, at some time, the rules no longer permit the distribution of such content, for example, at the end of a specified time period, the subroutine 252 also ends in step 408.

Preferably, content information is provided in multiple feeds that are not varied as various devices 78, 12, 14 begin receiving content information or cease to receive content information. The content information may be presented in a number of formats that are suitable for viewing, and listening including JPEG, MPEG, MPG, GIF, and data streaming.

While the server 26 has been described and shown as an individual device, it is understood that several devices, operating together, may be used to provide for a sufficient number of simultaneous calls, or that multiple servers may be assigned to provide different functions, such as content delivery or financial arrangements.

While several of the preferred embodiments or versions of the invention have been described with some degree of particularity, it is understood that this description has been given only by way of example, and that many changes can be made without departing from the spirit and scope of the invention, as defined in the appended claims.

What is claimed is:

1. A method creating and sharing graphical images among remote locations, wherein the method comprises:
forming a cluster of client systems connected to a server over a network by storing an address identifying each of the client systems in the cluster in an active cluster database within the server.
generating digital data representing graphical images in a plurality of the client systems
transmitting the digital data over the network to the server;
receiving the digital data within the server,
forming content including representations of graphical images represented within the digital data within the server,
forming a digital data feed including the content within the server, and
transmitting the digital data feed over the network to at least one of the client systems within the cluster, wherein composition and timing of the content within the digital data feed is not affected by actions of the client systems during transmission of the digital data feed.

2. The method of claim 1, wherein the cluster of client systems is formed by a method additionally comprising an administrative client system calling the server and transmitting the address identifying each of the client systems in the cluster to the server.

3. The method of claim 1, wherein the client systems within the cluster include
at least one active device having a microprocessor, a selection device, a display, and data and instruction storage, and
at least one passive device receiving digital data from the server and displaying images derived from the data without transmitting data not needed to establish a connection between the passive device and the server to the server.

4. The method of claim 1, additionally comprising transmitting a source suite program from the server to be downloaded by at least one of the client systems in the cluster, wherein the source suite program includes program instructions for generating digital data describing graphical images and for transmitting the digital data to the server over the network.

5. The method of claim 1, wherein the active cluster database additionally includes:
data describing source rules identifying client systems within the cluster as being capable of generating the digital data representing a graphical image and transmitting the digital data over the network to the server; and
data describing destination rules identifying when a client system is to receive the data feed and to display graphical images derived from the data feed.

6. The method of claim 5, wherein:
the cluster of client systems is formed by a method additionally comprising an administrative client system calling the server and transmitting the address identifying each of the client systems in the cluster to the server
information describing the source rules is transmitted to the server by the administrative client system transmitting the address identifying each of the client systems in the cluster to the server and updated with the transmission of digital data representing graphical images to the server, and
information describing the destination rules is transmitted to the server by the client system receiving the data feed.

7. The method of claim 1, wherein
the content formed within the server includes a project including a plurality of images formed by digital data transmitted to the server by a plurality of the client systems within the cluster;
data including representations of images within the plurality of images is stored in a work in progress database within the server until data including representations of all images within the project has been received.

8. The method of claim 1, wherein the server forms a plurality of digital data feeds including the content within the server, and transmits the digital data feeds over the network to a plurality of client systems within the cluster, wherein the composition and timing of the content within the digital data feed is not affected by actions of the client systems during transmission of each of the digital data feeds.

9. The method of claim 1, wherein the digital data feed is additionally transmitted from the server over the network to at least one client system outside the cluster.

10. A system for creating and sharing graphical images among remote locations, wherein the system comprises:
a plurality of client systems;
a network connected to each client system within the plurality of client systems;
a server additionally connected to the network, wherein the server includes data and instruction storage and a microprocessor programmed to perform a method comprising:
receiving a call from a client system within the plurality of client systems acting as an administrator;
receiving and storing data from the administrator defining a plurality of the client systems to be included within a cluster;
transmitting a source suite program to a plurality of the client systems included within the cluster, wherein the source suite program includes instructions for generating digital data describing graphical images and for transmitting the digital data to the server over the network;
receiving and storing digital data representing graphical images from a plurality of client systems within the cluster;
forming a digital data feed from the data received and stored from the plurality of client systems; and
transmitting the digital data feed to at least one client system within the cluster for display of the graphical images described therein.

11. The system of claim 10, wherein the method additionally comprises:
receiving and storing source rule data from the administrator identifying which client systems are to create and transmit the digital data describing graphical images, and
storing digital data representing graphical images only from client systems identified within the source rule data as being able to create and transmit the digital data describing graphical images.

12. The system of claim 11, wherein the method additionally comprises:
receiving and storing destination rule data from client systems identifying types of content to be received by the client systems; and
transmitting the digital data feed to the client systems according to the source rule data and the destination rule data.

13. The system of claim 12, wherein the method comprises:
forming a plurality of digital data feeds from the data received and stored from the plurality of client systems; and
transmitting each of the plurality of digital data feeds to the client systems according to the source rule data and the destination rule data, wherein the source rule data can store data indicating which of the digital data feeds is to be transmitted to a particular client system.

14. The system of claim 10, wherein
the source suite program includes instructions providing for tagging digital data representing a digital image to indicate that the digital data is part of a project including digital data representing at least one other digital images, and
the method additionally comprises identifying tagged data representing digital images as being a part of a project, storing tagged digital images until all digital images for a project have been received, and combining the digital data forming the project to form a portion of the digital data feed.

15. A computer readable medium having computer usable instructions written thereon causing a server to perform a method comprising:
receiving a call from a client system within the plurality of client systems acting as an administrator;
receiving and storing data from the administrator defining a plurality of the client systems to be included within a cluster;
transmitting a source suite program to a plurality of the client systems included within the cluster, wherein the source suite program includes instructions for generating digital data describing graphical images and for transmitting the digital data to the server over the network;
receiving and storing digital data representing graphical images from a plurality of client systems within the cluster;
forming a digital data feed from the data received and stored from the plurality of client systems; and
transmitting the digital data feed to at least one client system within the cluster for display of the graphical images described therein.

16. The computer readable medium of claim 15, wherein the method additionally comprises:
receiving and storing source rule data from the administrator identifying which client systems are to create and transmit the digital data describing graphical images, and
storing digital data representing graphical images only from client systems identified within the source rule data as being able to create and transmit the digital data describing graphical images.

17. The computer readable medium of claim 16, wherein the method additionally comprises:
receiving and storing destination rule data from client systems identifying types of content to be-received by the client systems; and
transmitting the digital data feed to the client systems according to the source rule data and the destination rule data.

18. The computer readable medium of claim 17, wherein the method comprises:
forming a plurality of digital data feeds from the data received and stored from the plurality of client systems; and
transmitting each of the plurality of digital data feeds to the client systems according to the source rule data and the destination rule data, wherein the source rule data can store data indicating which of the digital data feeds is to be transmitted to a particular client system.

19. The computer readable medium of claim 15, wherein
the source suite program includes instructions providing for tagging digital data representing a digital image to indicate that the digital data is part of a project including digital data representing at least one other digital images, and
the method additionally comprises identifying tagged data representing digital images as being a part of a project, storing tagged digital images until all digital images for a project have been received, and combining the digital data forming the project to form a portion of the digital data feed.
